(19) United States
(12) Patent Application Publication
(10) Pub. No.: US 2021/0048560 A1
(43) Pub. Date: Feb. 18, 2021

(54) MULTILAYER LENS FOR EYEGLASSES

(71) Applicant: LUXOTTICA S.R.L., Agordo (IT)

(72) Inventor: Giorgio DEGLI ANTONINI, Settimo Torinese (IT)

(21) Appl. No.: 16/969,305

(22) PCT Filed: Feb. 13, 2019
(86) PCT No.: PCT/EP2019/053568

§ 371 Date: Aug. 12, 2020

(30) Foreign Application Priority Data
Feb. 16, 2018 (IT) 102018000002744

(51) Int. Cl. G02B 1/115; G02B 1/14

(52) U.S. Cl. CPC G02B 1/115; G02B 1/14

(57) ABSTRACT

A multilayer lens for eyeglasses includes a substrate and at least one layer of precious metal. The layer of precious metal is arranged on the concave side of the substrate and is adapted to be directed toward the eye of the wearer of the lens. Eyeglasses may include one or more of these lenses.

### TECHNICAL FIELD

The present disclosure relates to a multilayer lens for eyeglasses. More specifically, the disclosure relates to a plastic multilayer lens for eyeglasses.

### BACKGROUND

As is known, multilayer lenses exist which contain a layer of precious metal inside them, such as gold or the like, in which the layer of precious metal is arranged toward the observer, i.e. in the position furthest from the eye of the wearer of the lens, with respect to a plastic substrate which constitutes the base element of the lens proper.

In other words, the layer of precious metal is deposited on the front side of the lens. Solutions of this type are known for example from EP2274648 and U.S. Pat. No. 8,449,109.

Plastic lenses with a layer of precious metal arranged on the outward side of the lens however have a number of drawbacks, including the fact that the layer of precious metal can be exposed to deterioration phenomena owing to rubbing, impact or aging.

Furthermore, lenses provided with a layer of precious metal also have a coating on the two mutually opposite faces of the lens, which is provided with a lacquer, and which causes unwanted iridescent effects.

In particular such lenses have an additional, scratch-resistant lacquer deposited on top of the layer of precious metal, which greatly compromises the cosmetic appearance of the precious metal owing to bothersome interference effects.

### SUMMARY

The aim of the present disclosure is to provide a multilayer lens for eyeglasses, which has at least one layer of precious metal that can be preserved from deterioration phenomena in general.

Within this aim, the present disclosure provides a multilayer lens for eyeglasses in which the quality of the lens is improved with respect to conventional lenses.

The present disclosure provides a multilayer lens for eyeglasses, which makes it possible to give the lens, viewed externally, a “metallic” effect while retaining the solar filtering qualities.

The present disclosure provides a multilayer lens for eyeglasses that is highly reliable, easily and practically implemented and at low cost.

This aim and these and other advantages which will become better apparent hereinafter are achieved by providing a multilayer lens for eyeglasses, which comprises a substrate and at least one layer of precious metal, characterized in that said layer of precious metal is arranged on the concave side of said substrate, adapted to be directed toward the eye of the wearer of the lens.

### BRIEF DESCRIPTION OF THE DRAWINGS

Further characteristics and advantages of the disclosure will become better apparent from the description of preferred, but not exclusive, embodiments of the lens according to the disclosure, which are illustrated by way of non-limiting example in the accompanying drawings wherein:

FIG. 1 schematically illustrates a lens according to the present disclosure, according to a first embodiment;

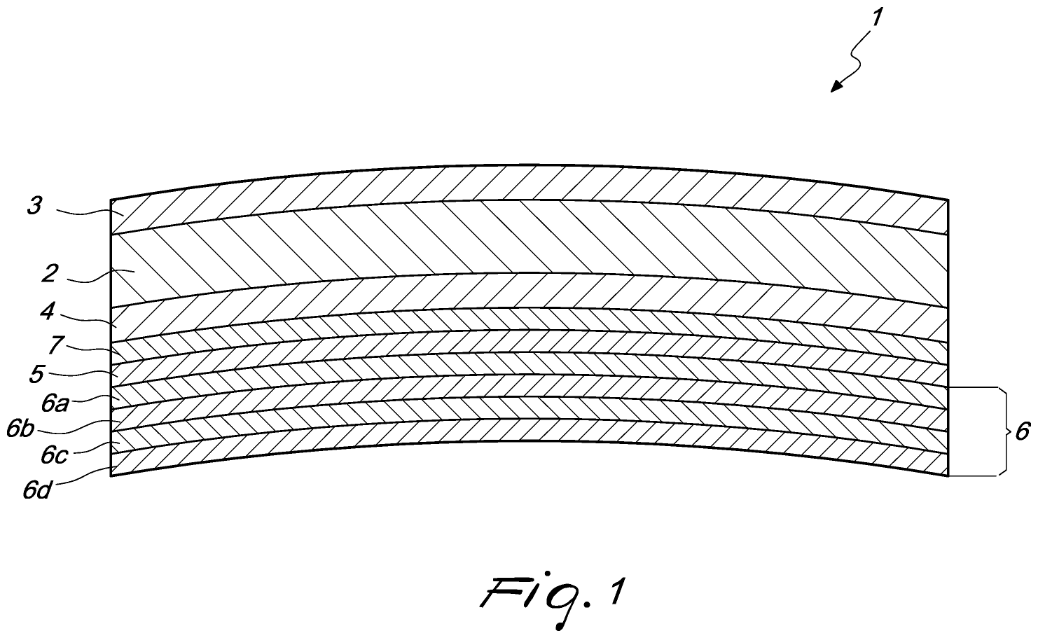

FIG. 2 schematically illustrates the lens according to the present disclosure, according to a second embodiment.

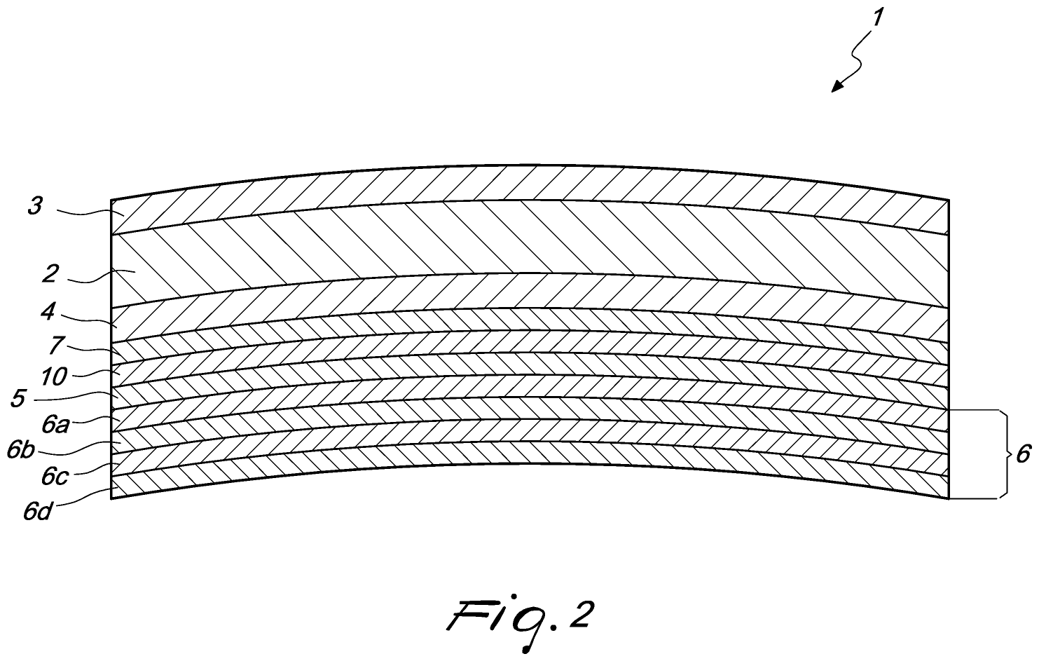

It should be noted that the term “lens” is used to mean a lens adapted to be mounted in a frame, and also a mask (where the frame is absent and the mask acts as a front), and also a visor mounted on a helmet.

### DETAILED DESCRIPTION OF THE DRAWINGS

With reference to the figures, the lens according to the present disclosure, according to the first embodiment, generally designated by the reference numeral 1, comprises a substrate, of plastic material 2, for example made of nylon, transparent, which is interposed between two layers 3 and 4 of scratch-resistant coating based on organic materials, in particular polysiloxane.

Alternatively the substrate 2 can be made of glass. Furthermore, the substrate, be it plastic material or glass, may or may not have an optical correction.

The two layers of scratch-resistant coating therefore protect the substrate 2 and prevent damage.

The scratch-resistant layer 3 is directed toward the outer side of the lens while the scratch-resistant layer 4 is directed toward the eye of the wearer of the lens.

A layer 5 of precious metal, such as for example gold, silver, platinum or optionally alloys thereof, is arranged at the side of the substrate 2 that is adapted to be directed toward the eye of the wearer of the lens. In substance, the layer of precious metal 5 is arranged on the concave side of the substrate 2.

Conveniently, interposed between the layer of precious metal 5 and the substrate 2 there is a layer of chromium 7 and the previously-described layer of scratch-resistant coating 4.

The function of the layer of chromium 7 is to promote adhesion between the layer of precious metal and the organic substrate.

It could be a layer of chromium, or a layer of silicon monoxide (SiO), or a mixture of both.

Alternatively, other metals could be used.

The layer 7 is to all intents and purposes an adhesion promotion layer.

On top of the layer of precious metal, at the layer directed toward the eye of the user of the lens, an anti-reflective layer 6 is furthermore applied, which can be constituted by a multiplicity of layers, for example 6a-6d.

With reference to the figures, in which the anti-reflective layer 6 is provided by four different layers, the layer 6a is a layer the first function of which is to promote adhesion between the layer of precious metal 5 and the layer 6b, which is a layer of silicon dioxide (SiO₂), otherwise such layer would not adhere to the layer of gold 5 and vice versa.

Furthermore, the layer 6a has a second function, as a layer with a high refractive index for providing the anti-reflective treatment, in a HLHL composition of layers.

Finally, the layer 6a has a third function, to reduce the transmittance of the lens (and therefore make it darker) in order to prevent the user of the lens from being dazzled by the reflection of the precious metal.

Therefore, the layer 6a is the first layer with a high refractive index, the layer 6b is a layer with a low refractive index, the layer 6c is another layer with a high refractive index and the layer 6d is a final layer with a low refractive index. Thus the composition HLHL is created.

The layer 6c, in addition to its first function as a layer with a high refractive index, has a second function, to reduce the transmittance of the lens (and therefore make it darker) in order to prevent the user of the lens from being dazzled by the reflection of the precious metal.

It should be noted that the anti-reflective layer 6 can be constituted by a minimum number of layers corresponding to the structure (HL)n with n equal to one, for example 6a-6b. The layers of material with a high refractive index are for example provided as T_{y}Oₓ, ZrₓO_{y}, etc., while the layers of material with a low refractive index are typically SiO₂ and MgF₂.

The layer 6d has two functions: one is to constitute the second layer with a low refractive index for the bundle of layers 6a-6d that constitute the HLHL structure, and the other one is to protect all the layers from the oxidation process due to the external environment and to mechanical stresses (for example scratches).

Conveniently the layer of precious metal 5 is provided by way of vacuum evaporation techniques.

In a second embodiment, the lens according to the present disclosure has a gold-red coloring, which is obtained by interposing a layer of copper 10 between the layer of precious metal 5 (in this case made of gold) and the layer adhesion promotion layer 7.

The layer of copper 10 has the twofold function of giving the layer of precious metal in gold 5 a gold-red color and at the same time contributing to the adhesion of the layer of precious metal 5 in conjunction with the adhesion promotion layer 7.

Optionally the layer 10 can be made with other materials by way of evaporation (both metals and non-metals) in order to give the gold a different coloring from its characteristic color, for example in order to obtain colorings like gold-purple, gold-green, gold-blue, gold-black, etc.

The lens thus provided makes it possible to protect the layer of precious metal from deterioration phenomena owing to rubbing, impact or aging.

In practice it has been found that the lens thus conceived achieves the intended aim and advantages, by making it possible to have a lens with a metallic effect owing to the presence of a layer of precious metal, but which at the same time is made in such a way as to protect the aforementioned layer as much as possible, unlike the solutions for a conventional lens in which a layer of precious metal is used.

Furthermore, the lens according to the disclosure makes it possible to completely eliminate the bothersome iridescence effect owing to the presence of lacquers on the two faces of the lens.

The lens thus conceived is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

The disclosures in Italian Patent Application No. 102018000002744 from which this application claims priority are incorporated herein by reference.

1-14. (canceled)

15. A multilayer lens for eyeglasses, the lens comprises:
a substrate; and
at least one layer of precious metal, wherein said layer of precious metal is arranged on a concave side of said substrate, adapted to be directed toward the eye of the wearer of the lens.

16. The lens according to claim 15, wherein said substrate is protected at its faces by a respective layer of scratch-resistant coating.

17. The lens according to claim 15, wherein said layer of precious metal is deposited on said layer of scratch-resistant coating, adapted to be directed toward the eye of the wearer of the lens, following an interposition of an adhesion promotion layer.

18. The lens according to claim 15, wherein said layer of precious metal is protected by an anti-reflective layer.

19. The lens according to claim 18, wherein said anti-reflective layer is composed of at least two layers.

20. The lens according to claim 19, wherein said at least two layers of said anti-reflective layer comprise an alternation of layers with a high refractive index and with a low refractive index.

21. The lens according to claim 19, wherein said anti-reflective layer comprises a first layer with a high refractive index configured for adhesion promotion, said first layer is arranged adjacent to said layer of precious metal.

22. The lens according to claim 21, wherein said anti-reflective layer comprises a second layer with a low refractive index, said second layer is arranged adjacent to said first layer with a high refractive index, a third layer with a low refractive index, and a fourth layer with a low refractive index.

23. The lens according to claim 15, wherein said substrate is a substrate of transparent plastic.

24. The lens according to claim 15, wherein said substrate is a substrate of glass.

25. The lens according to claim 16, wherein the layers of scratch-resistant coating arranged to protect the opposite faces of said substrate are layers based on organic materials.

26. The lens according to claim 15, wherein said layer of precious metal is a layer selected from the group consisting of gold, silver, platinum, palladium, ruthenium, rhodium, osmium, iridium, and alloys thereof.

27. The lens according to claim 17, further comprising a layer of copper between said layer of precious metal and said adhesion promotion layer.

28. Eyeglasses comprising one or more lenses according to claim 15.
